(19) United States
(12) Patent Application Publication
(10) Pub. No.: US 2011/0184741 A1
(43) Pub. Date: Jul. 28, 2011

(54) DEVICE, METHOD AND SYSTEM FOR VIRTUAL BUSINESS OPERATION BASED ON POSITIONING TECHNOLOGY

(75) Inventors: Yeong Sung Lin, Taipei (TW); Jen-Wel Chen, Taipei (TW); Pei Yu Chen, Taipei (TW); Yu Shun Wang, Taipei (TW); Yao-Yuan Chang, Taipei (TW); Shih-Chang Lin, Taipei (TW); Yi-Wei Li, Taipei (TW); Pin Hung Chen, Taipei (TW); Yung-Pin Tsai, Taipei (TW)

(73) Assignee: NATIONAL TAIWAN UNIVERSITY, Taipei (TW)

(21) Appl. No.: 12/839,679

(22) Filed: Jul. 20, 2010

(30) Foreign Application Priority Data
Jan. 26, 2010 (TW) 99102033

(51) Int. Cl. G06Q 10/00; G01S 19/42

(52) U.S. Cl. 705/1.1; 342/357.25

(57) ABSTRACT

A positioning-based virtual business operation system includes a seller equipment having a positioning device for acquiring positioning information of the seller equipment and a data transmitting/receiving device for transmitting the positioning information; an operation platform having a business information interface for receiving the positioning information of the seller equipment and updating location information of the seller equipment in the business information interface; and an operator equipment for transmitting operation service information to the operation platform via a network and adjusting service information of the seller equipment or operator information in the business information interface, thereby allowing consumers, mobile sellers, operators of virtual business, and operators of portal sites to benefit from the system and thus creating an all-beneficial business running pattern.

### BACKGROUND OF THE INVENTION

1. Field of the Invention

This invention relates to virtual business operation methods and systems, and more particularly, to a virtual business operation method and system in combination with positioning technologies.

2. Description of Related Art

In social activities, people sometimes need to determine geographic location or coordinates at which they are located. Accordingly, various positioning technologies come to the market. Global Positioning System (GPS) is one of the positioning technologies that is developed by the United States. GPS is applied to various application fields, such as resource investigation and exploration, navigation positioning, earth measurement, map-drawing, dynamic information related to locations, and precise timing. In general, users use a location dynamic information function of GPS. For instance, users use a GPS signal receiver, together with a map database, to make some calculation, and then the geographic locations of the users are displayed immediately. This is the way a general map information updating system (e.g., a GPS navigation device) operates.

In recent years, the positioning technologies may be readily combined with a network system, and be applied to various business application fields, such as vehicular navigation tracking systems and route planning systems. However, positioning technologies applicable to virtual business operation remain unavailable.

Virtual business means electronic business that combines a network and business. Initially, physical stores are publicized on homepages. Currently, virtual business not only involves placing a lot of stores on the Internet to conduct business behaviors but entails creating various groups connected by specific relationships, such as local virtual business or virtual business which trades in goods of similar nature. The greatest advantage of virtual business is that it bridges otherwise discrete geographic areas and allows sellers to contact with consumers better.

However, virtual business of the prior art has the following drawbacks.

(1) The types of goods sold and bought are limited. Conventional virtual business partners place orders by the Internet. However, some goods are not suitable to be sold and bought via the Internet, such as hot and iced food that can be easily rotten, purses/wallets delivered and collected in person, and shoes sent to footwear technicians for maintenance.

(2) Virtual business of the prior art is not applicable to mobile sellers. The mobile sellers, such as vendors, do not sell their goods at a fixed place but need to sell their goods to consumers in a face-to-face manner.

(3) Virtual business of the prior art cannot attract many consumers. Recently, a plethora of network-based stores come to the market, and many of them are dishonest. Seeing is believing. Consumers are unwilling to buy anything unless they see the goods in person.

(4) The network-based business is seldom lucrative. A network-based store owner usually runs a physical store as well, or has a contact phone number and address even if he has no physical store. Accordingly, after buying a piece of goods at a virtual business website once, consumers need not visit the website in order to buy the piece of goods again, and thus the network-based store owner cannot make profits by accumulating enough online consumers.

(5) Virtual business of the prior art lacks managers. In general, virtual business homepages are hosted by a portal site. The portal site operator is seldom motivated to take care of the management of the virtual business homepages. The owners of the virtual business homepages have to maintain the homepages independently, thereby resulting in deterioration of the quality of the homepages.

Therefore, it is imperative to provide a positioning-based virtual business operation device, method and system so as to solve the drawbacks of the prior art.

### SUMMARY OF THE INVENTION

In view of the above-mentioned problems of the prior art, the present invention provides a positioning-based virtual business operation device, method and system, which use positioning technologies to update mobile sellers' locations in map information of virtual business in a real-time manner.

The positioning-based virtual business operation system of the present invention includes at least a seller equipment having a positioning device for acquiring positioning information and a data transmitting/receiving device for transmitting the positioning information; an operation platform having at least a business information interface for receiving the positioning information of the seller equipment and updating location information of the seller equipment in the business information interface; and at least an operator equipment for transmitting via a network operation service information to the operation platform and adjusting service information of the seller equipment or operator information in the business information interface.

In a preferred embodiment, the operator equipment acquires authorization messages regarding specific operation areas of the business information interface in the operation platform, and adds/deletes/updates the business information or the service information of the seller equipment to/from/for the specific operation areas.

The positioning-based virtual business operation method of the present invention includes the following steps of: (1) enabling an operation platform having a business information interface to receive positioning information of at least a seller equipment and update location information of the seller equipment in the business information interface; and (2) enabling at least an operator equipment to transmit via a network the operation service information to the operation platform, for adjusting service information of the seller equipment or operator information in the business information interface.

In a preferred embodiment, the step of (1) further includes (1-1) enabling the seller equipment to receive the positioning information where the seller equipment is located; (1-2) enabling the seller equipment to transmit the positioning information and service information to the operation platform; and (1-3) enabling the operation platform to update location information and seller information of the seller equipment in the business information interface.

In another preferred embodiment, the step of (2) further includes: (2-1) enabling the operator equipment to acquire authorization messages regarding specific operation areas of the business information interface in the operation platform; (2-2) enabling the operator equipment to transmit via a network operation service information to the operation platform; and (2-3) enabling the operation platform to adjust the business information or service information of the seller equipment according to the operation service information in the specific operation areas of the business information interface.

The positioning-based virtual business operation device of the present invention includes a message receiving unit for receiving positioning information of at least a seller equipment; a map information unit for updating and displaying a location of the seller equipment in map information according to the positioning information; and an operator function unit for receiving operation service information to adjust business information or service information of the seller equipment and displaying them in the map information.

In a preferred embodiment, the virtual business operation device further includes a virtual business authorization unit for dividing the map information into a plurality of virtual business areas and generating corresponding authorization messages; and an identification unit for identifying an operator equipment that logins the virtual business operation device and directing the operator equipment to corresponding ones of the virtual business areas according to authorization messages input by the operator equipment.

Compared with the prior art, the positioning-based virtual business operation device, method and system of the present invention allow consumers to get mobile seller information quickly, enable mobile sellers that join the system to increases their sales, allow operators of virtual business to collect service fees from consumers and the mobile sellers, and allow operators of portal sites to collect royalties from the operators of the virtual business, thereby allowing the consumers, mobile sellers, operators of virtual business, and operators of portal sites to benefit from the positioning-based virtual business operation device, method and system of the present invention and thus creating an all-beneficial business running pattern.

### BRIEF DESCRIPTION OF DRAWINGS

The invention can be more fully understood by reading the following detailed description of the preferred embodiments, with reference made to the accompanying drawings, wherein:

FIG. 1 is a functional block diagram of an embodiment of a positioning-based virtual business operation system according to the present invention;

FIG. 2 is a flow chart of an embodiment of a positioning-based virtual business operation method according to the present invention;

FIG. 3 is a functional block diagram of an embodiment of a positioning-based virtual business operation device according to the present invention; and

FIG. 4 is a scenario-based schematic diagram of an application of a positioning-based virtual business operation system according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

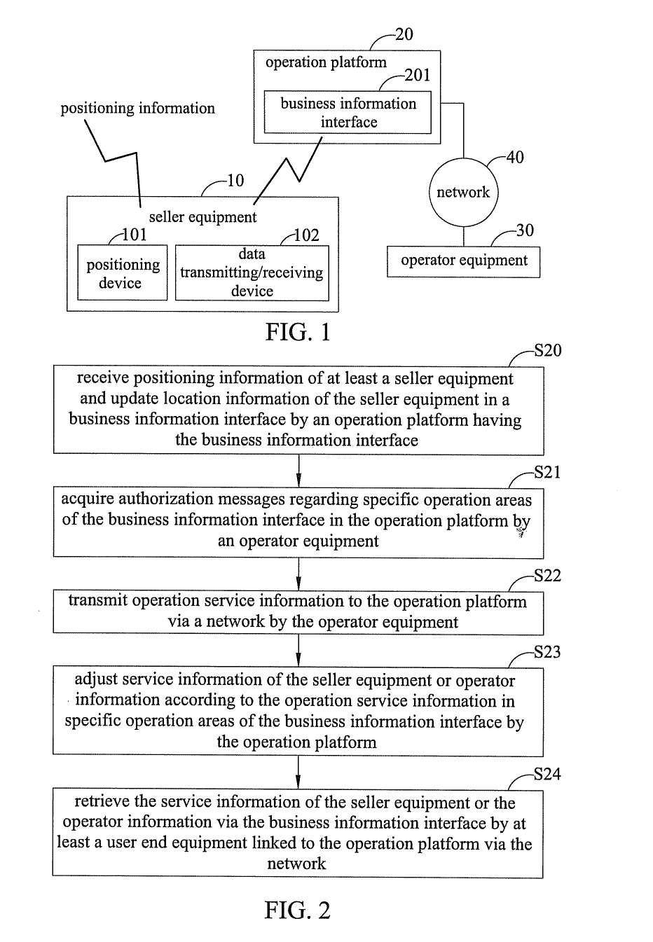

Please refer to FIG. 1, which is a functional block diagram of a positioning-based virtual business operation system according to the present invention. As shown in the drawing, the system comprises a seller equipment 10, an operation platform 20 and an operator equipment 30, wherein the operation platform 20 is linked via a network 40 to the operator equipment 30.

The seller equipment 10 has a positioning device 101 and a data transmitting/receiving device 102. The positioning device 101 is for receiving positioning information and enabling the seller equipment 10 to receive the positioning information and determine the location of the seller equipment 10 according to the positioning information received. Technologies applicable to the positioning device 101 of the present invention include, for example, a GPS positioning system, Galileo satellite system, wireless network positioning system, and mobile communications positioning system. The data transmitting/receiving device 102 is for transmitting or receiving various messages and data. For example, after the seller equipment 10 receives the positioning information, the data transmitting/receiving device 102 may transmit the positioning information to specific platforms, allowing the platforms to control where the seller equipment 10 is located.

The operation platform 20 has at least a business information interface 201, for updating the location information of the seller equipment 10 in the business information interface continuously after the operation platform 20 receives the positioning information of the seller equipment 10.

The operator equipment 30 may transmit via the network 40 operation service information to the operation platform 20 and to adjust service information of the seller equipment 10 or operator information in the business information interface 201.

In a preferred embodiment, the system further comprises at least a user end equipment that is linked to the operation platform 20 via the network 40 to thereby acquire the service information of the seller equipment 10 or the operator information via the business information interface 201.

In practice, the seller equipment 10 may be a mobile dining car equipped with a GPS signal receiver and a wireless communications device. The business information interface 201 of the operation platform 20 may be a map-typed display interface. When the mobile dining car is moving, GPS signals may be transmitted via the wireless communications device back to the operation platform 20, allowing the map-typed display interface to update the location of the mobile dining car continuously. Therefore, consumers may track down the location of the mobile dining car in real time via the map-typed display interface by linking to the operation platform 20. Furthermore, in the present invention the operator equipment 30 acts as a manager of the business information interface 201, and thus the operator equipment 30 may upload information related to business managed by the operator equipment 30, such as traffic conditions, promotions, or seller service contents, to the business information interface 201 of the operation platform 20. Furthermore, the mobile dining car may upload its business item messages, goods messages, concession messages or service messages to the operation platform 20 via the wireless communications device. Therefore, the consumers (i.e., the aforesaid user end equipment) may not only get the locations of mobile sellers, but also retrieve business related information via the business information interface 201, which greatly increases the consumers' willingness to link to the operation platform 20. On the other hand, the seller equipment 10 may also receive consumers' location information via the wireless communications device, so as for the mobile sellers to take the initiative in visiting the customers. For instance, once a consumer uploads service demand related information to the operation platform 20, the operation platform 20 will send the information to the seller equipment 10 providing corresponding service, thereby allowing interested or available mobile sellers to take the initiative in approaching the consumer. In a preferred embodiment, the operation platform 20 transmits route planning information to the consumers and the mobile sellers, so as to increase the convenience of transaction.

Although mobile sellers are disclosed and described in the aforesaid embodiments, persons skilled in the art should not interpret the aforesaid embodiments as a limit imposed on the scope of the claims of the present invention. Semi-mobile sellers and stationary sellers are also applicable to the system of the present invention. Consumers may find out, by making reference to the embodiments of the present invention, the locations of the semi-mobile sellers and stationary sellers and their service contents quickly.

In another preferred embodiment, the operation platform 20 calculates movement route messages, movement habit messages, stay time messages or location prediction messages regarding the seller equipment 10 according to the received location information of the seller equipment 10.

In yet another preferred embodiment, the operator equipment 30 acquires authorization messages related to specific operation areas and provided by the business information interface 201 in the operation platform 20, so as for the operator information or service information of the seller equipment 10 to be added to, removed from, or updated in the specific operation areas. For instance, the operation platform 20 divides the map information available in the business information interface 201 into a plurality of operating business areas, and sets a royalty for each of the operating business areas. When an operator plans to operate a virtual business area A, the operator may acquire authorization messages regarding the virtual business area A by paying the royalty to the operation platform 20 (e.g., a large portal site). Thereafter, the operator who is in possession of the authorization messages may manage and operate the virtual business area A. In the beginning, the operator may take the initiative in offering booths to all physical mobile sellers located in the virtual business area A. Since it is difficult for ordinary people to track down the routes of movement of mobile sellers, the mobile sellers find customers mostly from among casual visitors. By contrast, if the mobile sellers join the operation of the system, consumers at specific locations can be informed of the mobile sellers' whereabouts via a network in real time to thereby play an active, rather than passive, role in doing business with the mobile sellers (that is, the consumers take the initiative in doing business with the mobile sellers). In so doing, the mobile sellers' product sales has a good chance of being boosted, and the mobile sellers are willing to pay for their participation in the operation of the virtual business area A. Furthermore, if the virtual business area A congregates a lot of mobile sellers, consumers will get connected to the operation platform 20 for a longer time and more often to thereby increase advertisement profits made by the operation platform 20.

In a preferred embodiment, the seller equipment 10 may also link to the operation platform 20 so as to take the initiative in updating the map information in the business information interface 201. For instance, sellers may upload their service contents or latest concession promotion information to the operation platform 20, so as to update the map information in real time and display the contents and information uploaded by the sellers, thereby encouraging the consumers to link to the operation platform 20.

In another preferred embodiment, the aforesaid specific operation areas related to the business information interface are a virtual positioning space formed by a plurality of the positioning information.

Therefore, the positioning-based virtual business operation system of the present invention allows consumers to access mobile seller information quickly, increases the sales attained by those mobile sellers who join the system, allows operators of virtual business to collect service fees from consumers and mobile sellers, and allows operators of portal sites to collect royalties from the operators of virtual business, thereby allowing the consumers, mobile sellers, operators of virtual business, and operators of portal sites to benefit from the system and thus creating an all-beneficial business running pattern.

Please refer to FIG. 2, which is a flow chart of an embodiment of a positioning-based virtual business operation method according to the present invention. As shown in the drawing, the method comprises the following steps.

In step S20, an operation platform having a business information interface receives positioning information of at least a seller equipment, to update location information of the seller equipment in the business information interface. In a preferred embodiment, step S20 further comprises enabling the operation platform to calculate movement route messages, movement habit messages, stay time messages or location prediction messages regarding the seller equipment according to the received location information of the seller equipment. Proceed to step S21.

In step S21, the operator equipment acquires authorization messages regarding specific operation areas of the business information interface in the operation platform. Proceed to step S22.

In step S22, the operator equipment transmits operation service information to the operation platform via a network. Proceed to step S23.

In step S23, the operation platform adjusts the operator information or service information of the seller equipment according to the operation service information in specific operation areas of the business information interface. Then, proceed to step S24.

In step S24, at least a user end equipment links to the operation platform via the network, to retrieve the operator information or the service information of the seller equipment via the business information interface.

With the aforesaid method, current positioning technologies may be directed into mobile sellers who use cars or carts to sell goods. Therefore, consumers may go to the mobile sellers to consume or get services by browsing homepages with computers or cell phones according to the locations where the mobile sellers are located. On the other hands, the mobile sellers may download data of primary clients in an area where they are located via the operation platform, and provide home services.

Moreover, the mobile sellers may indicate where they are located in a communication positioning way by dialing cell phones, in order to reduce operation costs of the mobile sellers. Therefore, consumers may inquire in vicinity. Alternatively, the mobile sellers may be informed of where their business opportunities are located by short messages or vocal messages.

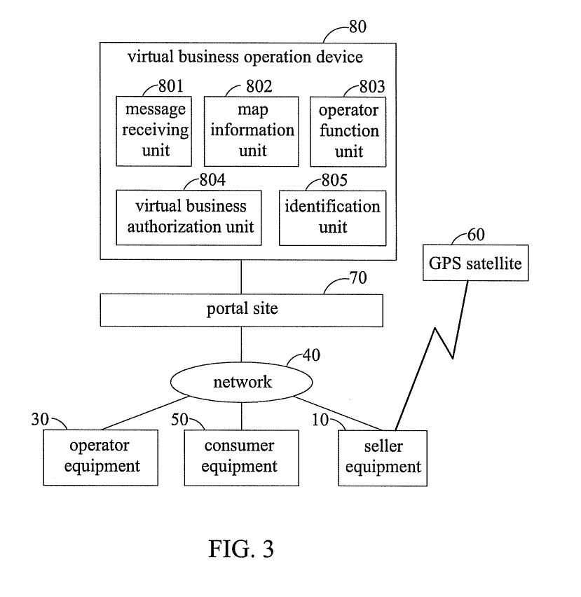

Please refer to FIG. 3, which is a functional block diagram of an embodiment of a positioning-based virtual business operation device 80 according to the present invention.

As shown in the figure, the positioning-based virtual business operation device 80 comprises a message receiving unit 801 for receiving positioning information of at least a seller equipment, a map information unit 802 for updating and displaying the location of the seller equipment in a map information according to the positioning information, an operator function unit 803 for receiving operation service information to adjust business information or service information of the seller equipment and displaying them in the map information, a virtual business authorization unit 804 for dividing the map information into a plurality of virtual business areas and generating corresponding authorization messages, and an identification unit 805 for identifying an operator equipment that logins the virtual business operation device and directing the operator equipment into corresponding ones of the virtual business areas according to authorization messages input by the operator equipment. The virtual business operation device 80 may be a network site, a homepage server or any kind of network platforms.

In practice, the virtual business operation device 80 is installed at a rear end of the portal site 70, and the seller equipment 10 may transmit via the network 40 positioning information and other goods information from the GPS satellite 60 to the virtual business operation device 80 via the portal site 70. On the other hand, the operator equipment 30 links via the network 40 to the virtual business operation device 80, so as to manage virtual business areas belonging thereof. Therefore, the consumer equipment 50 may link to the virtual business operation device 80 to acquire various flowing seller information.

In an embodiment, the device of the present invention further comprises a seller function unit for receiving goods messages, concession messages or service messages uploaded by the seller equipment and displaying them in the map information.

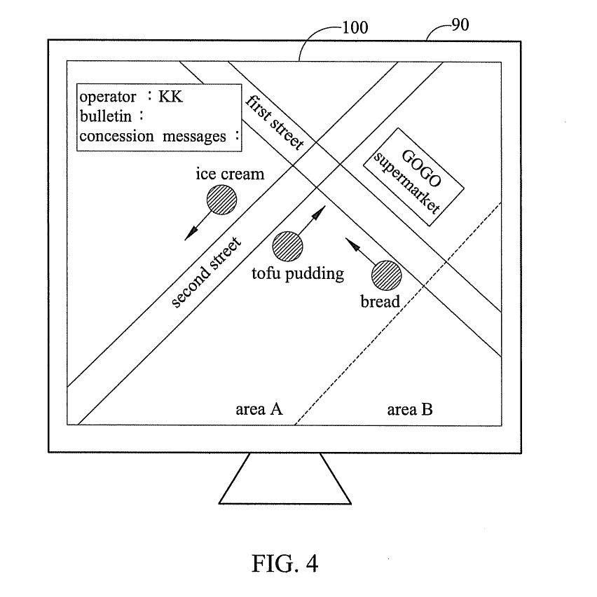

Please refer to FIG. 4, which is a scenario-based schematic diagram of an application of a positioning-based virtual business operation system according to the present invention.

In the embodiment, the present invention introduces a virtual positioning space concept. The present invention uses positioning signals to establish a digital virtual space, and mark a virtual positioning space according to application and requirement of business operators. After acquiring license of a network site, the operators of the virtual positioning space may recruit booths with mobile sellers or stationary sellers, and attract consumers to use them with specific positioning space market. When entering the positioning space market, consumers see nothing but the recruited seller information filtered by the business operator. In order to attract a lot of consumers to link to the positioning space market, the business operator has to recruit sellers continuously and provide various value-added service. Besides, the same positioning space may be operated by different business operators by submitting fees or by a single business operator according to operation items.

As shown in the figure, in a screen 90 is a display interface 100 of the virtual positioning space, where KK indicates an operator in a positioning space A, and the bottom right corner of the screen 90 is a positioning space B. After linked to a virtual business network site, a consumer who is in a supermarket located in the intersection of a first street and a second street finds out at the positioning space A that there are mobile sellers who sell ice cream, tofu pudding and bread in the vicinity of the supermarket, and inquires his movement direction and route. Accordingly, the consumer may get the time needed for the mobile sellers to arrive the supermarket. Therefore, the consumer's shopping convenience is greatly improved.

The operator KK for the positioning space A may also combine with other sellers to broadcast concession messages casually, or bulletin information related to the positioning space A on a display interface, so as to attract consumes to link and use seller information of the positioning space A.

In sum, the positioning-based virtual business operation device, method and system may generate the following effects.

(1) The types of transaction goods are not limited. Although the present invention is a virtual business operation system that is embodied via a network, sellers may still transact with buyers face to face. Compared with the prior art, the present invention does not limit the typed of transaction goods.

(2) The present invention is applicable to mobile sellers. Conventional network shopping mechanism is established based on stationary sellers, while the present invention combine positioning technologies such that the virtual business operation mode may be applicable to mobile sellers.

allowing all users to be benefited from the system and thus creating an all-beneficial business running pattern.

(3) The present invention allows consumers, mobile sellers, virtual business operator and portal sites to be benefited from the system and thus creates an all-beneficial business running pattern. The present invention also allows consumers to transact with mobile sellers conveniently in a face-to-face manner. Virtual business operators may, based on area manager identity, collect management fees or service fees from consumers and mobile seller, and portal site operators may license virtual positioning space to specific operators and collect royalties, so as to increase advertisement profit.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A positioning-based virtual business operation system, comprising:
at least a seller equipment having a positioning device for acquiring positioning information and a data transmitting/receiving device for transmitting the positioning information;
an operation platform having at least a business information interface for receiving the positioning information of the seller equipment and updating location information of the seller equipment in the business information interface; and
at least an operator equipment for transmitting operation service information to the operation platform via a network and adjusting service information of the seller equipment or operator information in the business information interface.

2. The virtual business operation system of claim 1, further comprising a user end equipment linked to the operation platform via the network to thereby retrieve the service information of the seller equipment or the operator information via the business information interface.

3. The virtual business operation system of claim 1, wherein the positioning information is GPS positioning information.

4. The virtual business operation system of claim 1, wherein the seller equipment uploads business item messages, goods messages, concession messages or service messages to the operation platform via the data transmitting/receiving device.

5. The virtual business operation system of claim 1, wherein the operation platform calculates movement route messages, movement habit messages, stay time messages or location prediction messages regarding the seller equipment according to the location information of the seller equipment.

6. The virtual business operation system of claim 1, wherein the operator equipment acquires authorization messages regarding specific operation areas of the business information interface in the operation platform, so as for the operator information or the service information of the seller equipment to be added to, removed from, or updated in the specific operation areas.

7. The virtual business operation system of claim 6, wherein the specific operation areas of the business information interface are a virtual positioning space formed by a plurality of said positioning information.

8. A positioning-based virtual business operation method, comprising the steps of:
(1) receiving, by an operation platform having a business information interface, positioning information of at least a seller equipment, followed by updating location information of the seller equipment in the business information interface; and
(2) transmitting operation service information to the operation platform by at least an operator equipment via a network, followed by adjusting service information of the seller equipment or operator information in the business information interface.

9. The virtual business operation method of claim 8, further comprising step (3):
enabling at least a user end equipment to link to the operation platform via the network, followed by retrieving the operator information or the service information of the seller equipment via the business information interface.

10. The virtual business operation method of claim 8, wherein step (1) further comprises calculating, by the operation platform, movement route messages, movement habit messages, stay time messages or location prediction messages regarding the seller equipment according to the positioning information of the seller equipment.

11. The virtual business operation method of claim 8, wherein step (1) further comprises the sub-steps of:
(1-1) receiving the positioning information related to a location of the seller equipment by the seller equipment;
(1-2) transmitting the positioning information and service information to the operation platform by the seller equipment; and
(1-3) updating location information and seller information of the seller equipment in the business information interface by the operation platform.

12. The virtual business operation method of claim 11, wherein the seller information is goods messages, concession messages, or service messages.

13. The virtual business operation method of claim 8, wherein step (2) further comprises the sub-steps of:
(2-1) acquiring authorization messages regarding specific operation areas of the business information interface in the operation platform by the operator equipment;
(2-2) transmitting, by the operator equipment, operation service information to the operation platform via the network; and
(2-3) adjusting, by the operation platform, the operator information or service information of the seller equipment according to the operation service information in the specific operation areas of the business information interface.

14. A positioning-based virtual business operation device, comprising:
a message receiving unit for receiving positioning information of at least a seller equipment;
a map information unit for updating and displaying a location of the seller equipment in map information according to the positioning information; and
an operator function unit for receiving operation service information to adjust operator information or service information of the seller equipment and displaying them in the map information.

15. The virtual business operation device of claim 14, further comprising:
a virtual business authorization unit for dividing the map information into a plurality of virtual business areas and generating corresponding authorization messages; and
an identification unit for identifying an operator equipment that logins the virtual business operation device and directing the operator equipment to corresponding ones of the virtual business areas according to authorization messages input by the operator equipment.

16. The virtual business operation device of claim 14, further comprising a seller function unit for receiving goods messages, concession messages, or service messages uploaded by the seller equipment and displaying them in the map information.
